(19) United States
(12) Patent Application Publication
(10) Pub. No.: US 2023/0024572 A1
(43) Pub. Date: Jan. 26, 2023

(54) SOFTWARE MANAGEMENT SYSTEM, METHOD, AND STORAGE MEDIUM

(71) Applicant: TOYOTA JIDOSHA KABUSHIKI KAISHA, Toyota-shi (JP)

(72) Inventor: Shun SATO, Nagoya-shi (JP)

(73) Assignee: TOYOTA JIDOSHA KABUSHIKI KAISHA, Toyota-shi (JP)

(21) Appl. No.: 17/841,107

(22) Filed: Jun. 15, 2022

(30) Foreign Application Priority Data
Jul. 26, 2021 (JP) 2021-121347

(51) Int. Cl. G06Q 30/02

(52) U.S. Cl. CPC G06Q 30/0206

(57) ABSTRACT

A software management system includes a demand releasing unit configured to release a demand on software from a user to one or more developers, a demand identification unit configured to identify a demand from the user, which is the same or similar to a demand to be resolved by software created by the developer, and a fee determining unit configured to determine a usage fee for the software management system, to be paid by the developer that has created the software to resolve the demand that is the same or similar to the demand from the user.

### CROSS-REFERENCE TO RELATED APPLICATION

This application claims priority to Japanese Patent Application No. 2021-121347 filed on Jul. 26, 2021, incorporated herein by reference in its entirety.

### BACKGROUND

### 1. Technical Field

The disclosure relates to a software management system, a method, and a storage medium.

### 2. Description of Related Art

There are services that release software created by developers on sites and allow users to purchase the software. As one example of such services, a content transfer system described in Japanese Unexamined Patent Application Publication No. 2003-296606 (JP 2003-296606 A) extracts content that meets a request from an applicant user that desires to use the content and permits the applicant user to use the content, and also collects a price from the applicant user and pays the price to the provider of the content.

### SUMMARY

However, the content transfer system described in JP 2003-296606 A permits an applicant user to use content and also collects a price from the applicant user and pays the price to the provider of the content, so it is not possible to determine a usage fee for the content transfer system, to be paid by a developer, based on the contents of a demand from a user and the contents of software created by the developer.

The disclosure provides a software management system, a method, and a storage medium capable of determining a usage fee to be paid by a developer, based on the contents of a demand from a user and the contents of software created by the developer.

A first aspect of the disclosure provides a software management system. The software management system includes a demand releasing unit configured to release a demand on software from a user to one or more developers, a demand identification unit configured to identify the demand from the user, which is the same or similar to a demand to be resolved by software created by the developer, and a fee determining unit configured to determine a usage fee for the software management system, to be paid by the developer that has created the software to resolve the demand that is the same or similar to the demand from the user.

The fee determining unit may be configured to reduce the usage fee in accordance with a degree of resolution to which the demand is resolved by the software and that is determined by the user.

The demand identification unit may be configured to identify a first demand that is a demand that coincides with the demand to be resolved by the software created by the developer, and a second demand similar to the first demand. The fee determining unit may be configured to request a first user that has made the first demand and a second user that has made the second demand, for the degree of resolution.

The software management system may further include a similarity calculation unit configured to, when a character string describing contents of the first demand and a character string describing contents of the second demand are input, output a similarity between the contents of the first demand and the contents of the second demand. The fee determining unit may be configured to request the first user and the second user that has made the second demand with the similarity higher than or equal to a predetermined value, for the degree of resolution.

The degree of resolution of the demand may be determined in accordance with an advantage obtained by the software. The fee determining unit may be configured to reduce the usage fee in accordance with the advantage and the degree of resolution determined by the user.

The demand releasing unit may be configured to not release information on the advantage to the developer.

The software management system may further include a tag estimation unit configured to estimate a tag associated with the software based on contents of a function of the software created by the developer, and a software registration unit configured to register the tag estimated by the tag estimation unit in association with the software.

Another aspect of the disclosure provides a method. The method includes releasing, by a computer, a demand on software from a user to one or more developers, identifying, by the computer, the demand from the user, which is the same or similar to a demand to be resolved by software created by the developer, and determining, by the computer, a usage fee for a software management system that manages the software, to be paid by the developer that has created the software to resolve the demand that is the same or similar to the demand from the user.

Further another aspect of the disclosure provides a storage medium. The storage medium stores a program that causes a computer to execute functions. The functions include releasing a demand on software from a user to one or more developers, identifying the demand from the user, which is the same or similar to a demand to be resolved by software created by the developer, and determining a usage fee for a software management system that manages the software, to be paid by the developer that has created the software to resolve the demand that is the same or similar to the demand from the user.

According to the aspects of the disclosure, it is possible to provide a software management system, a method, and a storage medium capable of determining a usage fee to be paid by a developer, based on the contents of a demand from a user and the contents of software created by the developer.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 is a diagram showing an example of a software management system according to an embodiment of the disclosure;

FIG. 2 is a block diagram showing the configuration of a management server according to the embodiment of the disclosure;

FIG. 3 is a table showing an example of information on a demand from a user, registered in the management server according to the embodiment of the disclosure;

FIG. 4 is a table showing an example of information associated with software;

FIG. 5 is a block diagram showing the configuration of a developer terminal according to the embodiment of the disclosure;

FIG. 6 is a block diagram showing the configuration of a user terminal according to the embodiment of the disclosure;

FIG. 7 is a view showing an example of the sequence of a process that is executed in the software management system according to the embodiment of the disclosure;

FIG. 8 is a view showing another example of the sequence of a process that is executed in the software management system according to the embodiment of the disclosure;

FIG. 9 is a view showing further another example of the sequence of a process that is executed in the software management system according to the embodiment of the disclosure;

FIG. 10 is a table showing an example of a correspondence relationship between a degree of resolution and an evaluation index of software according to the embodiment of the disclosure; and

FIG. 11 is a table showing an example of a correspondence relationship between a settlement price and an evaluation index of software according to the embodiment of the disclosure.

### DETAILED DESCRIPTION OF EMBODIMENTS

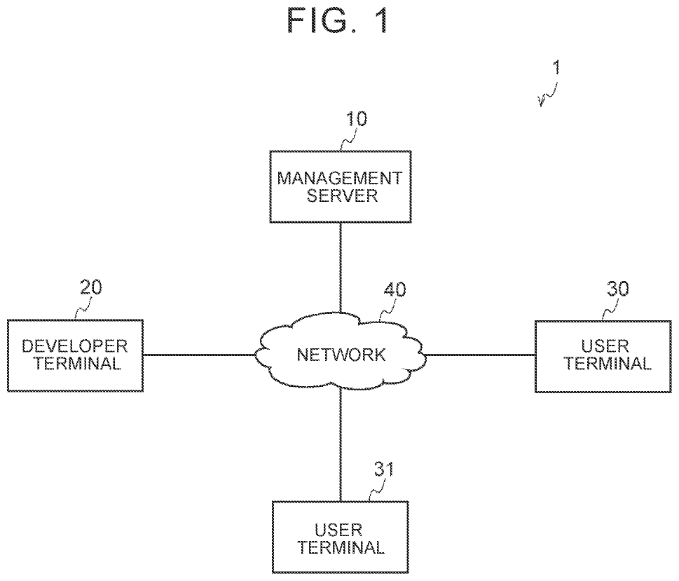

Hereinafter, an embodiment of the disclosure will be described with reference to the accompanying drawings. FIG. 1 is a diagram showing an example of a software management system according to the embodiment of the disclosure. The software management system 1 is a system for providing software according to a demand from a user. The software management system 1 includes a management server 10, a developer terminal 20, and user terminals 30, 31. The management server 10 is capable of communicating with the developer terminal 20 and the user terminals 30, 31 via a network 40 including a local area network (LAN) and/or a wide area network (WAN). The numbers of the developer terminals 20 and the user terminals 30, 31 included in the software management system 1 are not limited to the numbers shown in FIG. 1.

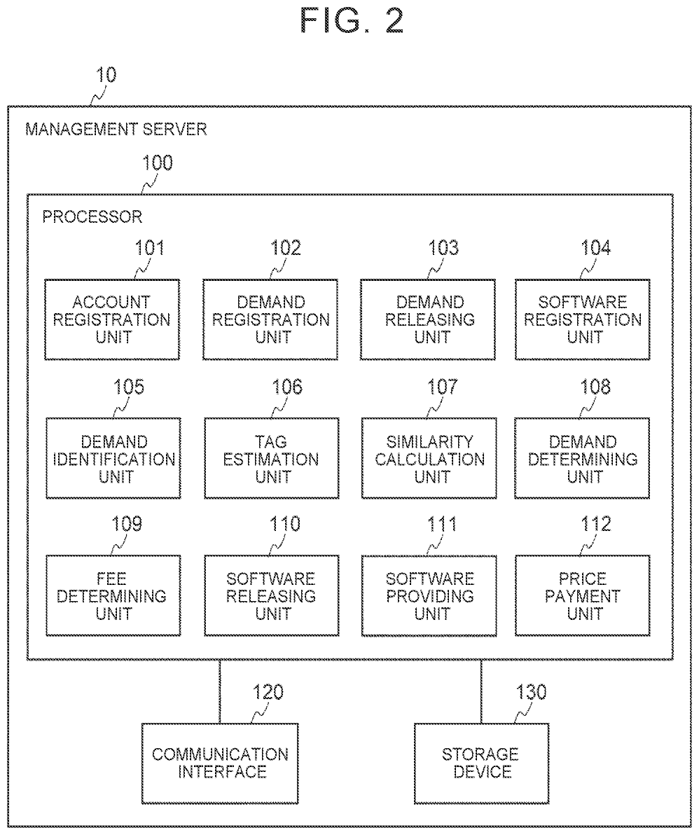

FIG. 2 is a block diagram showing the configuration of the management server 10 according to the embodiment of the disclosure. The management server 10 is an information processing apparatus that manages software created by developers. The management server 10 may be regarded as a management apparatus. The management server 10 includes a processor 100, a communication interface 120, and a storage device 130.

The processor 100 is a processor, such as a central processing unit (CPU) and a micro processing unit (MPU), that controls electronic circuits and devices included in the management server 10. The processor 100 executes a method according to the aspect of the disclosure by reading a program from the storage device 130 and running the program. The program to be run by the processor 100 includes an account registration unit 101, a demand registration unit 102, a demand releasing unit 103, a software registration unit 104, a demand identification unit 105, a tag estimation unit 106, a similarity calculation unit 107, a demand determining unit 108, a fee determining unit 109, a software releasing unit 110, a software providing unit 111, and a price payment unit 112.

The account registration unit 101 is a program that registers developer account information in a database. Developer account information includes identification information (hereinafter, referred to as “ID”) of the developer and the type of software that the developer can create. Examples of the type of software that the developer can create include an application program and other programs. When software that the developer can create includes programs other than an application program, account information also includes the programming languages of the programs. A database in which account information is registered is able to be constructed in the storage device 130 of the management server 10.

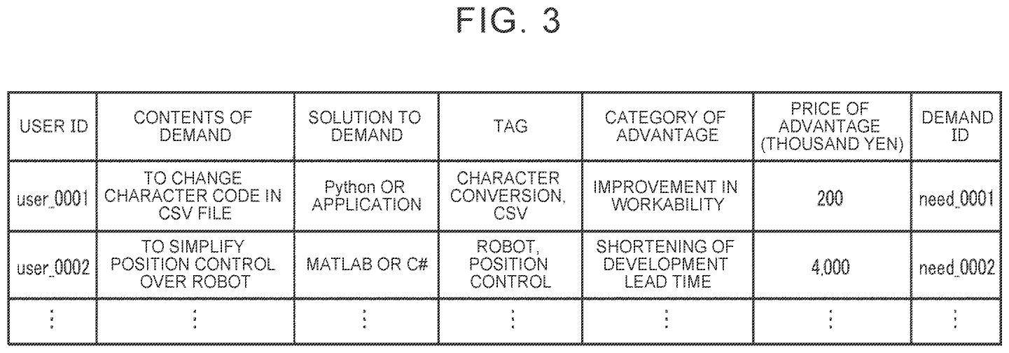

The demand registration unit 102 is a program that registers demands on software from users in a database (hereinafter, referred to as “user demand database”). The demand registration unit 102 assigns an ID to each of the demands from users and, as shown in FIG. 3, registers information on the demands from the users in the user demand database in association with the corresponding demand IDs.

As shown in FIG. 3, information on a demand from a user includes information that indicates a user ID, the contents of the demand, a solution to the demand, a character string related to the demand (hereinafter, referred to as “tag”), and the category and price of advantage made by software.

A user ID is the identification information of a user. General users and business users are assumed as users. The contents of a demand are information that describes the contents of the demand from a user.

A solution to a demand includes the type and programming language of software. Examples of the type of software include an application program and other programs. In the case of a program other than an application program, a solution to a demand includes a programming language.

A tag is a character string that describes the contents of a demand. For example, a keyword that describes the contents of a demand from a user may be adopted as a tag. A tag may be composed of a single word or a compound word. A user is able to set a selected tag.

The category of advantage made by software is information that indicates the category of advantage obtained by software. Examples of the category of advantage made by software include improvement in workability and shortening of a development lead time. The price of advantage made by software is a price that indicates a monetary advantage obtained by software. The price of advantage is able to be determined by a business user.

The demand releasing unit 103 is a program that releases information on a demand from a user to one or more developers. The demand releasing unit 103 releases information on a demand from a user to developers by placing the developer terminal 20 in a state accessible to the information on the demand from the user. Of the information on the demand from the user, the demand releasing unit 103 releases the contents of the demand, a solution to the demand, and a tag. On the other hand, the demand releasing unit 103 does not release information that indicates a user ID and the category and price of advantage made by software.

The software registration unit 104 is a program that registers software created by a developer. The software registration unit 104 assigns an ID to software created by a developer and saves the software and information related to the software in the storage device 130 in association with the software ID. The software registration unit 104 may save software and information related to the software in another storage device that the management server 10 is able to access.

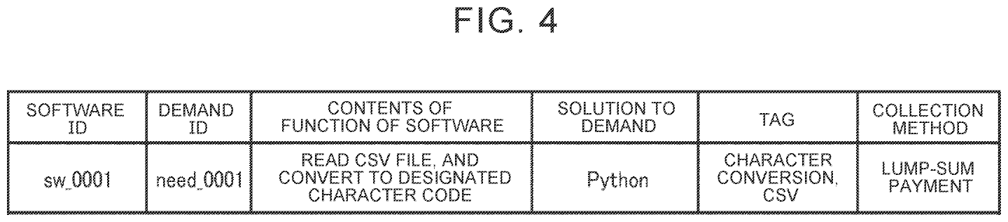

FIG. 4 is a table showing an example of information related to software that the software registration unit 104 registers. Information related to software includes a demand ID, the contents of the function of the software, a solution to a demand, a tag, and a collection method. These pieces of information are registered in a database (hereinafter, referred to as “software database”) in association with a software ID.

A demand ID is the identification information of a demand to be resolved by software identified by a software ID. The contents of the function of software are the contents of the function provided by the software and are described by a selected character string.

A solution to a demand is a solution to a demand to be resolved by the software. For example, examples of the type of software include an application program and other programs. In the case of a program other than an application program, a solution to a demand includes a programming language.

A tag is a character string that describes the contents of a demand to be resolved by the software. For example, a keyword that describes the contents of a demand from a user may be adopted as a tag. A tag may be composed of a single word or a compound word. A collection method is a method of paying a price to a developer. Examples of the method of paying a price include a lump-sum payment and a charge in an application program.

The demand identification unit 105 is a program that identifies a demand from a user, which is the same or similar to a demand to be resolved by software created by a developer, from the user demand database. Specifically, the demand identification unit 105 consults the user demand database and identifies the contents of a first demand associated with a demand ID that coincides with the demand ID of a demand designated by a developer and to be resolved by software for registration.

The tag estimation unit 106 is a program that estimates a tag associated with software created by a developer, based on the contents of the function of the software. The tag estimation unit 106 is implemented by a tag estimation model that is able to be subjected to machine learning, such as deep learning. The tag estimation model is able to be trained by using, for example, the contents of a demand registered in the user demand database and a tag associated with the contents of the demand. When a single word included in a character string that describes the contents of the function of software created by a developer is input, the tag estimation model outputs a tag (hereinafter, referred to as “estimated tag”) associated with the software. The software registration unit 104 registers the tag estimated by the tag estimation unit 106 in the software database in association with the software.

The demand identification unit 105 selects a tag that coincides with the estimated tag from among tags designated by a developer at the time of registration of software. Subsequently, the demand identification unit 105 selects the contents of a second demand associated with a solution to a demand, which coincides with the solution to the demand designated by the developer at the time of registration and associated with the tag that coincides with the estimated tag, from the user demand database.

The similarity calculation unit 107 is a program that calculates the similarity between the contents of the first demand and the contents of the second demand. The similarity calculation unit 107 is implemented by a similarity calculation model that is able to be subjected to machine learning, such as deep learning. The similarity calculation model is able to be trained by using, for example, a pair of similar character strings. When a character string that describes the contents of a first demand and a character string that describes the contents of a second demand are input, the similarity calculation model calculates the similarity therebetween. The demand identification unit 105 identifies a second demand of which the similarity calculated by the similarity calculation unit 107 is higher than or equal to a predetermined value, from among the selected contents of the second demand.

The demand determining unit 108 is a program that determines whether the ID of a demand associated with a user ID of a business user is included in the ID of the first demand and the ID of the second demand, identified by the demand identification unit 105.

The fee determining unit 109 is a program that determines a usage fee to be paid for using the software management system 1 by a developer that has created software. The usage fee can be reduced in accordance with a degree to which a demand is resolved by software.

The software releasing unit 110 is a program that releases software created by a developer. The software providing unit 111 is a program that provides software designated by a user to a corresponding one of the user terminals 30, 31.

The price payment unit 112 is a program that pays the price of software on sale to a developer that has created the software.

The communication interface 120 is an interface that performs data communication with the developer terminal 20 and the user terminals 30, 31.

The storage device 130 is a storage device in which various pieces of data including information on a demand from a user, information related to software, and databases are saved.

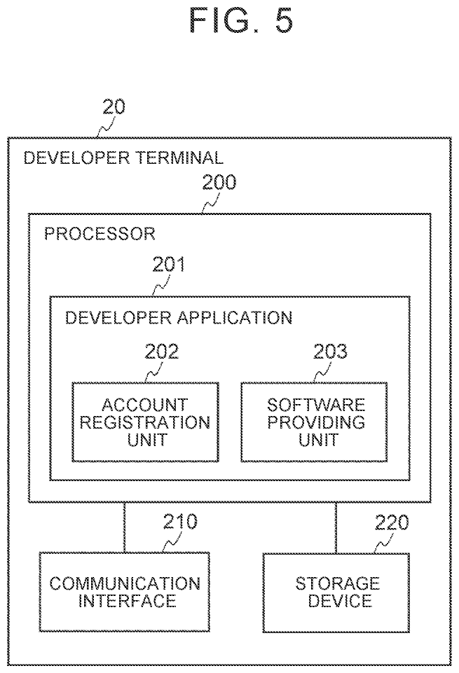

FIG. 5 is a block diagram showing the configuration of the developer terminal 20 according to the embodiment of the disclosure. The developer terminal 20 is an information processing apparatus with which a developer registers an account and uploads software. Developers include members of the public. The developer terminal 20 includes a processor 200, a communication interface 210, and a storage device 220.

The processor 200 is a processor, such as a CPU and an MPU, that controls electronic circuits and devices included in the developer terminal 20. The processor 200 executes a method according to the embodiment of the disclosure by reading a developer application 201 from the storage device 220 and running the developer application 201.

The developer application 201 includes an account registration unit 202 and a software providing unit 203. The account registration unit 202 is a program that provides developer account information to the management server 10 for registration. The software providing unit 203 is a program that provides software developed by a developer and information related to the software to the management server 10.

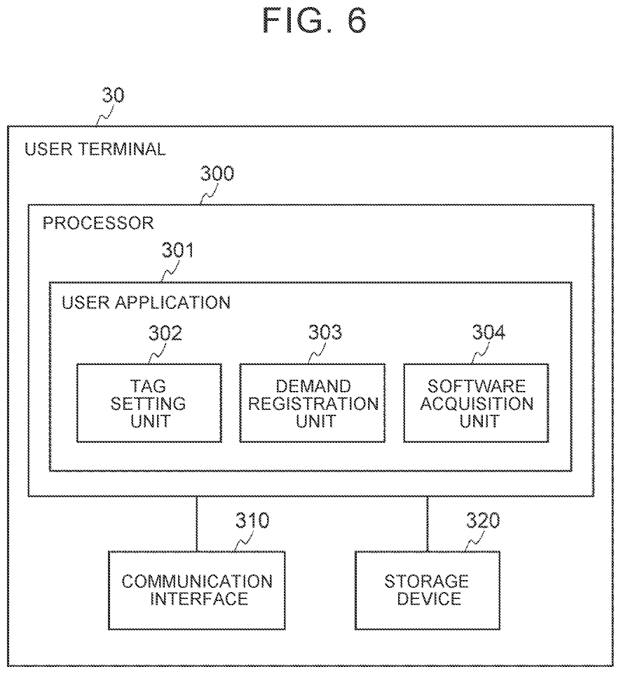

FIG. 6 is a block diagram showing the configuration of the user terminal 30 according to the embodiment of the disclosure. The user terminal 30 is an information processing apparatus with which a user registers a demand and downloads software from the management server 10. The user terminal 30 includes a processor 300, a communication interface 310, and a storage device 320.

The processor 300 is a processor, such as a CPU and an MPU, that controls electronic circuits and devices included in the user terminal 30. The processor 300 executes a method according to the embodiment of the disclosure by reading a user application 301 from the storage device 320 and running the user application 301. The user application 301 is also installed in the user terminal 31.

The user application 301 includes a tag setting unit 302, a demand registration unit 303, and a software acquisition unit 304. The tag setting unit 302 is a program that sets a tag related to a demand from a user. The tag setting unit 302 has a search function and is capable of selecting a tag desired by a user from a library in which a plurality of tags is registered. The tag setting unit 302 is also capable of analyzing the contents of a demand from a user and generating a tag by extracting a keyword from the contents of the demand. A keyword includes a term described in the contents of a demand from a user and synonyms of the term.

The demand registration unit 303 is a program that causes the management server 10 to register information related to a demand from a user. When the user is a business user, the demand registration unit 303 provides information that indicates the contents of a demand, a tag related to the demand, a solution to the demand, and the category and price of advantage of software together with the user ID.

On the other hand, when the user is a general user, the demand registration unit 303 provides information that indicates the contents of a demand, a tag related to the demand, and a solution to the demand, together with the user ID. In this case, the demand registration unit 303 does not provide information that indicates the category and price of advantage of software.

The software acquisition unit 304 is a program that acquires software that matches a demand from a user, from the management server 10. The software acquisition unit 304 displays information related to software released by the management server 10 on the display screen of the user terminal 30.

In the case of a business user, when the user selects desired software, the software acquisition unit 304 transmits the ID of the selected software to the management server 10. Subsequently, the management server 10 provides the selected software to the user terminal 30 or the user terminal 31 of the business user.

In the case of a general user, when the user selects desired software, the software acquisition unit 304 transmits the ID of the selected software and a purchase request for the software to the management server 10. Subsequently, the user terminal 30 or the user terminal 31 executes a payment process. When the management server 10 confirms completion of the payment process, the management server 10 provides the selected software to the user terminal 30 or the user terminal 31 of the business user.

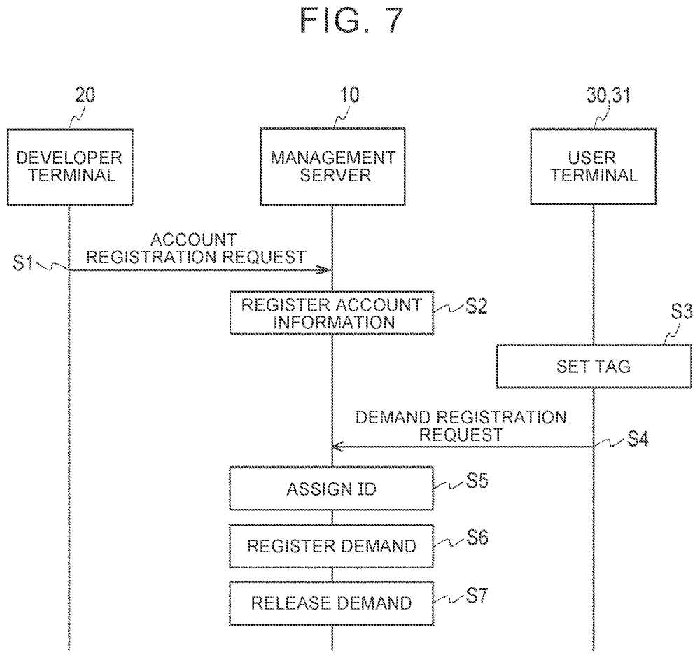

FIG. 7 is a view showing an example of the sequence of a process that is executed in the software management system 1.

In step S1, a developer transmits an account registration request to the management server 10 together with developer account information with the use of the developer terminal 20. When the management server 10 receives the account registration request, the management server 10 registers the developer account information in the database of the management server 10 in step S2.

In step S3, a user sets a tag related to a demand to be registered with the use of the user terminal 30 or the user terminal 31. The user is able to select a tag from among tags registered in the user database of the management server 10 by using a word search or the like. The user is also able to set a selected tag.

In step S4, the user terminal 30 or the user terminal 31 transmits a demand registration request to the management server 10. When the user is a business user, the user terminal 30 or the user terminal 31, that the business user uses, provides information that indicates the ID of the user, the contents of a demand, the tag related to the demand, a solution to the demand, and the category and price of advantage of software, together with the demand registration request. On the other hand, when the user is a general user, the user terminal 30 or the user terminal 31, that the general user uses, provides information that indicates the ID of the user, the contents of a demand, a tag related to the demand, and a solution to the demand, together with the demand registration request.

When the management server 10 receives the demand registration request from the user terminal 30 or the user terminal 31, the management server 10 assigns an ID to the demand to be registered, in step S5. In step S6, the management server 10, as shown in FIG. 3, registers information on the demand to be registered, in the database. In step S7, the management server 10 releases part of the information on the registered demand.

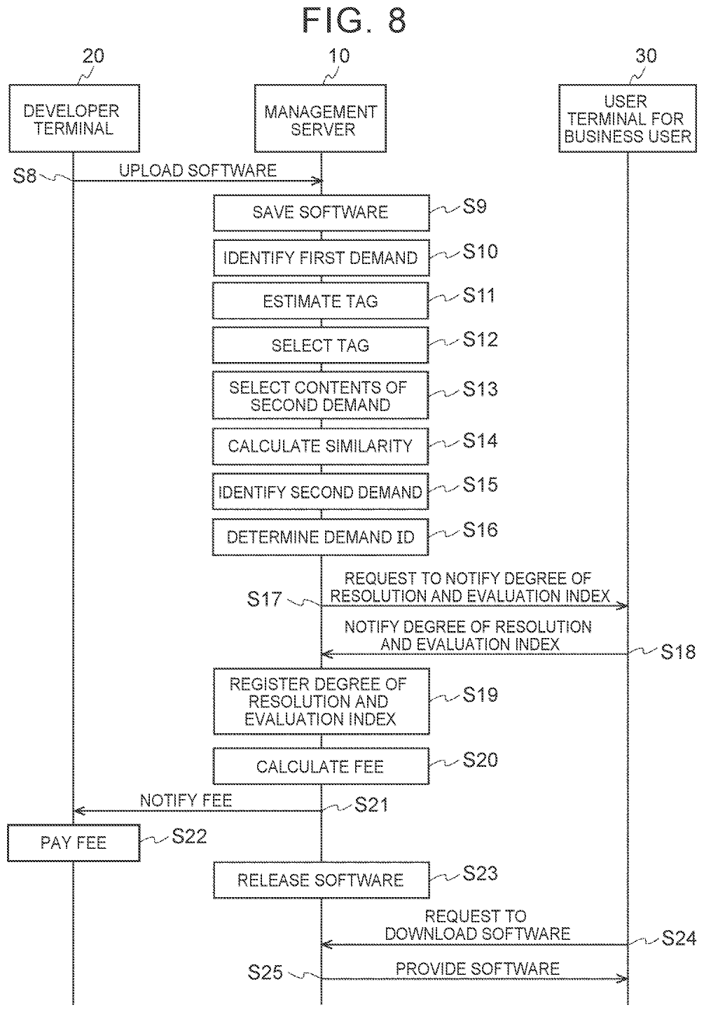

FIG. 8 is a view showing an example of the sequence of a process that is executed in the software management system 1 when the user is a business user.

In step S8, the developer uploads software to the management server 10 together with information related to the software as shown in FIG. 4 with the use of the developer terminal 20.

When the management server 10 receives the software from the developer terminal 20, the software registration unit 104 saves the software and the information related to the software in step S9. In step S10, the demand identification unit 105 identifies a first demand that coincides with the demand associated with the software, from the user demand database.

In step S11, the tag estimation unit 106 estimates a tag based on the contents of the function of the software created by the developer. In step S12, the demand identification unit 105 selects a tag that coincides with the estimated tag from among tags designated by the developer at the time of registration of the software. In step S13, the demand identification unit 105 selects a solution to the demand designated by the developer at the time of registration, the solution to the demand that coincides with the estimated tag, and the contents of a second demand associated with the tag, from the user demand database

In step S14, the similarity calculation unit 107 calculates the similarity between the contents of the first demand and the contents of the second demand. In step S15, the demand identification unit 105 identifies a second demand of which the similarity calculated by the similarity calculation unit 107 is higher than or equal to a predetermined value, from among the selected contents of the second demand.

In step S16, the demand determining unit 108 determines whether the ID of the demand associated with the user ID of the business user is included in the IDs of the demands identified by the software registration unit 104. The processes of step S17, step S18, and step S19 are executed when the ID of the demand associated with the user ID of the business user is included in the identified IDs of the demands.

In step S17, the fee determining unit 109 of the management server 10 transmits a request to notify a degree of resolution and an evaluation index to the user terminal 30 of the business user. A degree of resolution is an index that indicates a degree to which a demand is resolved by the software, and indicates the degree of contribution of the software to a corporation or the like. At this time, the management server 10 transmits information that indicates the contents of the function of the software to the user terminal 30 of the business user together with the request to notify the degree of resolution. The management server 10 is able to transmit the request to notify the degree of resolution to the user terminal 30 by using, for example, an e-mail or the like.

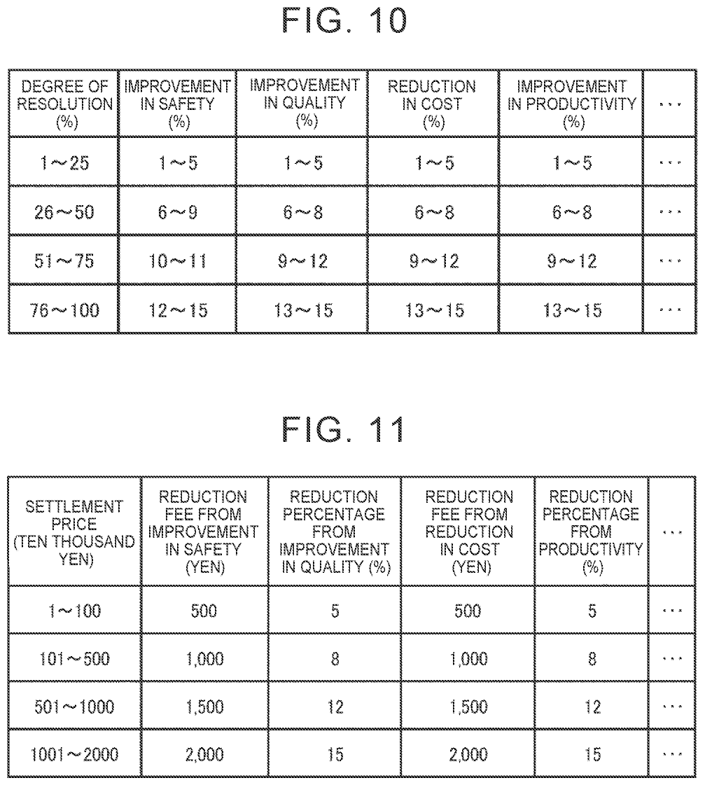

The business user checks the information that indicates the contents of the function of the software and determines the degree of resolution to which the demand is resolved by the software. Specifically, the business user is able to determine the degree of resolution to which the demand is resolved by the software, based on the correspondence relationship between a degree of resolution and an evaluation index of software, shown in FIG. 10. An evaluation index of software is an index for evaluating software created by a developer. For example, an advantage made by software, such as improvement in safety, improvement in quality, reduction in cost, and improvement in productivity, may be adopted as an evaluation index of software. When, for example, a business user determines that safety is improved by 10% by software, a degree of resolution is able to be determined within the range of 51% to 75%.

When the business user determines the degree of resolution to which the demand is resolved by the software, the user terminal 30 of the business user notifies the management server 10 of the degree of resolution determined by the user and the evaluation index taken into consideration at the time of determining the degree of resolution, in step S18. When the management server 10 receives the degree of resolution and the evaluation index from the user terminal 30 of the business user, the software registration unit 104 registers the degree of resolution and the evaluation index in the software database in association with the software ID in step S19.

In step S20, the fee determining unit 109 calculates a usage fee for the developer of the software to use the software management system 1. Specifically, the fee determining unit 109 calculates a settlement price by multiplying the degree of resolution determined by the business user by the price of advantage associated with the demand to be resolved by the software in the user demand database, as expressed by the mathematical expression 1. A settlement price is a price that indicates an economical advantage (reduction in cost, or the like) that the software created by the developer brings about in a corporation, an organization, or the like to which the business user belongs. As the settlement price increases, it means that the degree of contribution to a corporation, an organization, or the like increases.

(Settlement Price)=(Degree of Resolution)×(Evaluated Price)

Subsequently, the fee determining unit 109 determines a reduction fee and/or a reduction rate of a basic fee based on the calculated settlement price and the evaluation index of the software, provided from the business user, and calculates a usage fee. A basic fee is a fee that is a reference at the time of determining a usage fee and is able to be determined by an administrator of the software management system 1. Specifically, the fee determining unit 109 is able to determine the reduction fee and/or reduction rate of a basic fee in accordance with the correspondence relationship between a settlement price and a reduction fee and/or reduction rate based on the evaluation index of the software, as shown in FIG. 11. For example, an advantage made by software, such as improvement in safety, improvement in quality, reduction in cost, and improvement in productivity, may be adopted as an evaluation index of software.

A method of determining a reduction fee and a reduction rate in the case where the correspondence relationship shown in FIG. 11 is adopted will be described. When the calculated settlement price provided by the software is 5,000,000 yen and information indicating the evaluation index of the software, provided from the business user, includes improvement in safety and improvement in quality, the fee determining unit 109 determines “1,000 yen” as a reduction fee from improvement in safety and “8%” as a reduction percentage from improvement in quality. When the basic fee is 10,000 yen, the fee determining unit 109 calculates 8,280 yen (=(10,000 yen−1,000 yen)×(1−0.08)) as a usage fee. The usage fee is a price calculated in the case where improvement in safety is given a higher priority. On the other hand, when improvement in quality is given a higher priority, the fee determining unit 109 is able to calculate 8,200 yen (=10,000 yen×(1−0.08)−1,000 yen) as a usage fee.

In step S21, the fee determining unit 109 notifies the usage fee determined by the fee determining unit 109 to the developer terminal 20 of the developer that has created the software. In step S22, the developer pays the usage fee. In step S23, the software releasing unit 110 releases the software created by the developer.

Subsequently, the business user browses the released software and selects the software, and transmits a request to download the software to the management server 10 by using the user terminal 30 in step S24. When the management server 10 receives the request to download the software, the software providing unit 111 provides the software to the user terminal 30 of the business user in step S25.

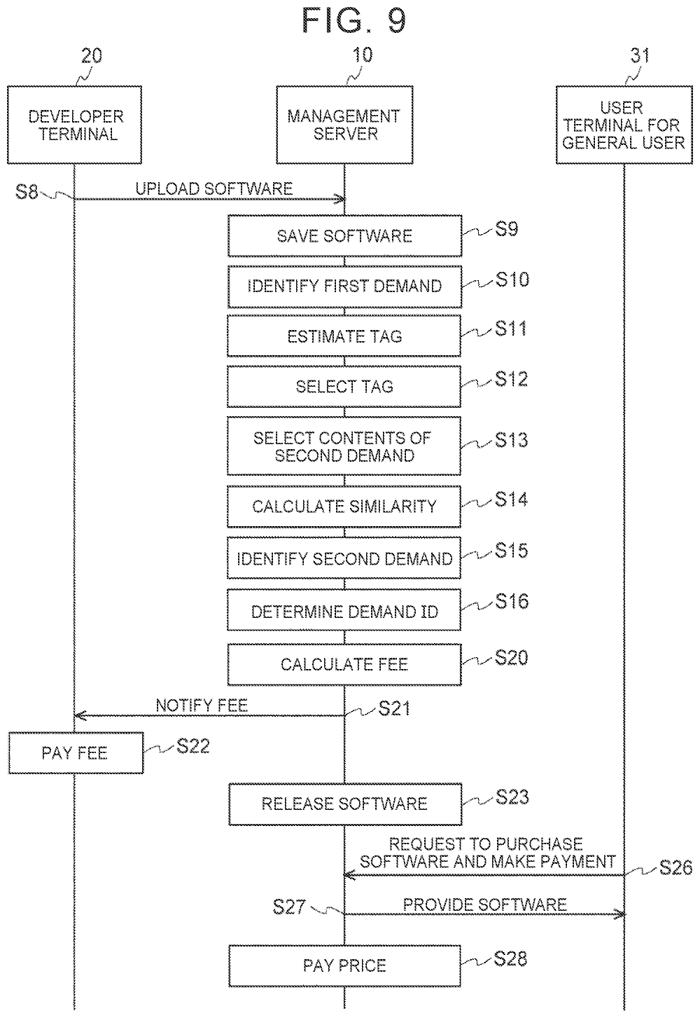

FIG. 9 is a view showing an example of the sequence of a process that is executed in the software management system 1 when the user is a general user. A general user does not determine a degree of resolution, and a usage fee to be paid by a developer is a basic fee. The processes of step S8, step S9, step S10, step S11, step S12, step S13, step S14, step S15, step S16, step S20, step S21, step S22, and step S23 shown in FIG. 9 are the same as step S8, step S9, step S10, step S11, step S12, step S13, step S14, step S15, step S16, step S20, step S21, step S22, and step S23 shown in FIG. 8. When the user is a general user, the processes of step S17, step S18, and step S19 are not executed.

The general user browses the released software and selects the software, and transmits a request to purchase the software to the management server 10 and executes a payment process by using the user terminal 31 in step S26. When the management server 10 receives the request to download the software and confirms completion of the payment process, the software providing unit 111 provides the software to the user terminal 31 of the general user in step S27. In step S28, the price payment unit 112 pays the price of the software on sale to the developer that has created the software.

In the above-described embodiment, the demand releasing unit 103 releases a demand on software from a user to one or more developers. The demand identification unit 105 identifies the demand from the user, which is the same or similar to a demand to be resolved by software created by the developer. The fee determining unit 109 determines a usage fee for the software management system 1, to be paid by the developer that has created the software to resolve the demand that is the same or similar to the demand from the user. Thus, it is possible to determine a usage fee to be paid by a developer in accordance with the contents of a demand from a user and the contents of software created by the developer.

The fee determining unit 109 reduces the usage fee in accordance with a degree of resolution to which the demand is resolved by the software and that is determined by the user. Thus, it is possible to incorporate determination of a user on a degree of resolution of a demand into a usage fee. Since a usage fee to be paid by a developer is reduced in accordance with a degree of resolution of a demand, it is possible to promote developers' motivation for development.

The demand identification unit 105 identifies a first demand that is a demand that coincides with the demand to be resolved by the software created by the developer, and a second demand similar to the first demand. The fee determining unit 109 requests a first user that has made the first demand and a second user that has made the second demand, for the degree of resolution to which the demand is resolved by the software. Thus, it is possible to request only the first user that has made a demand that coincides with the demand to be resolved by the software and a second user that has made a demand similar to the demand to be resolved by the software, for a degree of resolution.

When a character string describing the contents of the first demand and a character string describing the contents of the second demand are input, the similarity calculation unit 107 outputs a similarity between the contents of the first demand and the contents of the second demand. The fee determining unit 109 requests a first user and a second user that has made the second demand of which the similarity is higher than or equal to a predetermined value, for the degree of resolution to which the demand is resolved by the software. Thus, the second user that has made the second demand of which the similarity is less than the predetermined value is not requested for the degree of resolution, so an appropriate degree of resolution is determined.

The degree of resolution to which the demand is resolved by the software created by the developer is determined in accordance with an advantage obtained by the software. The fee determining unit 109 reduces the usage fee in accordance with the advantage and the degree of resolution of the demand, determined by the user. Thus, a usage fee is reduced in accordance with an advantage obtained by the software.

The demand releasing unit 103 does not release information on the advantage obtained by the software to the developer. Thus, it is possible to conceal information on an advantage obtained by the software with high confidentiality to the developer.

The tag estimation unit 106 estimates a tag associated with the software based on the contents of the function of the software created by the developer. The software registration unit 104 registers the tag estimated by the tag estimation unit 106 in association with software created by the developer. Thus, the tag estimated by the tag estimation unit 106 is registered in association with software, so an appropriate tag is associated with software.

In another embodiment, in determining a usage fee, it is possible to adopt a minimum fee. A minimum fee may be determined by an administrator of the software management system 1. When the fee determining unit 109 calculates a usage fee based on a degree of resolution and evaluation index determined by a business user and, as a result, the calculated usage fee becomes lower than a minimum fee, the minimum fee may be determined as a usage fee. Thus, even when a usage fee is reduced, the administrator of the software management system 1 is able to ensure a minimum fee.

In another embodiment, the fee determining unit 109 is able to determine a usage fee in accordance with the amount of sales of software. The fee determining unit 109 determines a usage fee based on a reduction fee and/or a reduction rate according to the amount of sales of software. As the amount of sales of software increases, a reduction fee and/or a reduction rate may be increased. For example, the fee determining unit 109 may determine a usage fee by multiplying the sales price of software by “1−(Reduction rate)”. The fee determining unit 109 may determine a usage fee by subtracting a reduction fee from a basic fee.

In the above example, a program includes a command set (or software code) for causing a computer to execute one or more functions described in the embodiment when the program is loaded onto the computer. The program may be stored in a non-transitory computer-readable medium or tangible storage medium. Nonrestrictive examples of the computer-readable medium or tangible storage medium include memory technologies, such as a random-access memory (RAM), a read-only memory (ROM), a flash memory, a solid-state drive (SSD), and others, optical disk storages, such as a CD-ROM, a digital versatile disc (DVD), a Blu-ray (registered trademark) disc, and others, and magnetic storage devices, such as a magnetic cassette, a magnetic tape, a magnetic disk storage, and others. The program may be transmitted on a transitory computer-readable medium or communication medium. Nonrestrictive examples of the temporary computer-readable medium or communication medium include an electrical, optical, acoustic, or other-type propagation signals. Examples of the computer include various devices, such as a personal computer (PC), a server, a CPU, an MPU, a field-programmable gate array (FPGA), and an application specific integrated circuit (ASIC).

The disclosure is not limited to the above-described embodiment and may be modified as needed without departing from the scope of the disclosure.

What is claimed is:

1. A software management system that manages software, the software management system comprising:
a demand releasing unit configured to release a demand on software from a user to one or more developers;
a demand identification unit configured to identify the demand from the user, which is the same or similar to a demand to be resolved by software created by the developer; and
a fee determining unit configured to determine a usage fee for the software management system, to be paid by the developer that has created the software to resolve a demand that is the same or similar to the demand from the user.

2. The software management system according to claim 1, wherein the fee determining unit is configured to reduce the usage fee in accordance with a degree of resolution to which the demand is resolved by the software and that is determined by the user.

3. The software management system according to claim 2, wherein:
the demand identification unit is configured to identify a first demand that is a demand that coincides with the demand to be resolved by the software created by the developer, and a second demand similar to the first demand; and
the fee determining unit is configured to request a first user that has made the first demand and a second user that has made the second demand, for the degree of resolution.

4. The software management system according to claim 3, further comprising a similarity calculation unit configured to, when a character string describing contents of the first demand and a character string describing contents of the second demand are input, output a similarity between the contents of the first demand and the contents of the second demand, wherein
the fee determining unit is configured to request the first user and the second user that has made the second demand with the similarity higher than or equal to a predetermined value, for the degree of resolution.

5. The software management system according to claim 2, wherein:
the degree of resolution of the demand is determined in accordance with an advantage obtained by the software; and
the fee determining unit is configured to reduce the usage fee in accordance with the advantage and the degree of resolution determined by the user.

6. The software management system according to claim 5, wherein the demand releasing unit is configured to not release information on the advantage to the developer.

7. The software management system according to claim 1, further comprising:
a tag estimation unit configured to estimate a tag associated with the software based on contents of a function of the software created by the developer; and
a software registration unit configured to register the tag estimated by the tag estimation unit in association with the software.

8. A method comprising:
releasing, by a computer, a demand on software from a user to one or more developers;
identifying, by the computer, the demand from the user, which is the same or similar to a demand to be resolved by software created by the developer; and
determining, by the computer, a usage fee for a software management system that manages the software, to be paid by the developer that has created the software to resolve the demand that is the same or similar to the demand from the user.

9. A non-transitory storage medium storing a program that causes a computer to execute functions comprising:
releasing a demand on software from a user to one or more developers;
identifying the demand from the user, which is the same or similar to a demand to be resolved by software created by the developer; and
determining a usage fee for a software management system that manages the software, to be paid by the developer that has created the software to resolve the demand that is the same or similar to the demand from the user.
